(19) United States
(12) Patent Application Publication
(10) Pub. No.: US 2014/0162048 A1
(43) Pub. Date: Jun. 12, 2014

(54) MULTI-LAYER LIQUID-DIODE FABRIC AND PRODUCTS

(71) Applicant: CALIFORNIA INSTITUTE OF TECHNOLOGY, Pasadena, CA (US)

(72) Inventors: Amir Gat, Pasadena, CA (US); Aria Vahdani, Los Angeles, CA (US); Morteza Gharib, Altadena, CA (US)

(73) Assignee: CALIFORNIA INSTITUTE OF TECHNOLOGY, Pasadena, CA (US)

(21) Appl. No.: 13/948,051

(22) Filed: Jul. 22, 2013

Related U.S. Application Data
(60) Provisional application No. 61/674,467, filed on Jul. 23, 2012.
(60) Provisional application No. 61/676,109, filed on Jul. 26, 2012.

(51) Int. Cl. B32B 5/02; F16K 15/14; A43B 1/00; A41D 27/00; A43B 17/00

(52) U.S. Cl. CPC B32B 5/02; A41D 27/00; A43B 17/003; A43B 1/00; F16K 15/14
USPC 428/311.11; 428/221; 428/351; 2/69; 2/239; 36/83; 137/843

(57) ABSTRACT

Multi-layer fabrics and products incorporating the same are described in which the fabrics are configured to provide asymmetric resistance to liquid flow from one side of the fabric to the other. In garments or other products worn by a user, the effect can be utilized to prevent penetration of liquids (e.g., rain droplets) and contact of liquids from the exterior with the user's skin while allowing for extraction of droplets (e.g., sweat) in contact with an inner layer of the fabric out of contact with the skin and accelerating their evaporation. Medical and industrial applications of the fabric are contemplated as well.

### RELATED APPLICATIONS

This application claims priority to and the benefit of U.S. Provisional Patent Application Ser. No. 61/674,467, filed Jul. 23, 2012, and Ser. No. 61/676,109 filed Jul. 26, 2012, each of which is incorporated herein by reference in its entirety for all purposes.

### FIELD

The embodiments described herein relate to high performance moisture-management fabrics and products incorporating the same.

### BACKGROUND

Current methods to create so-called “breathable” fabrics include hydrophobic materials that prevent both liquid penetration and exit from the fabric (e.g., GOR-TEX hydrophobic DWR coating), while allowing for vapor transfer. Other so-called “performance/high-performance” fabrics exist as well. DRIRELEASE by Optimer Brands, for example, employs a mix of 85 to 90 percent polyester (hydrophobic) with the remainder being cotton (hydrophilic) fibers in its fabrics. In its garments, this blend is said to pull moisture and perspiration away from the skin and push it out of the fabric for improved evaporation. COOLMAX fabric by Invista (formerly DuPont Textiles and Interiors) features a polyester fiber design in which the fibers have modified cross sectional profile to create closely spaced channels to provide capillary action to wick moisture through the core of the fabric and out to a wider area on the surface for increasing evaporation.

GOR-TEX fabric materials are employed in the manufacture of breathable but waterproof rainwear, liners in boots, etc. Given its PTFE-based construction, it also finds use in medical implants, filter media, insulation for wires and cables, gaskets, and sealants.

DRIRELEASE and COOLMAX fabric is utilized in a range of garments from mountain climbing gear and sportswear to underwear. Even mattress covers and bed sheets have been produces using one or more of these fabrics.

Thus, it is apparent that a plethora of applications exist for high performance moisture management fibers and fabrics produced therefrom. Improvement in their properties and an extended range of applicability is desirable.

### SUMMARY

Many of the example embodiments described herein address the need for further improved high-performance fabrics. These embodiments, in the form of fabrics, offer potential for improvement in terms of fluid transport efficacy and/or tunability over known products. Indeed, fabrics described herein (optionally referred to herein as diodic fabrics) provide asymmetric wicking properties by which liquid is preferentially transported from one side of the fabric the other. These dynamics offer an entirely new range of possibilities for products incorporating such diodic fabrics.

Embodiments of the diodic fabric are produced utilizing two or more materials with different capillary pressure drop (defined as the decrease in liquid pressure within a hydrophilic porous material due to capillary forces). Different capillary pressure drops can be achieved by different pore radius and/or different wetting properties of the porous material. In terms of utilizing pore radius, capillary pressure drop is inversely proportional thereto.

A double-layered fabric was found to have low wicking rate in one direction and high in the other direction, similarly to the asymmetric electrical resistance properties of a diode. The asymmetric wicking properties were found to correlate with asymmetric times required for evaporation of the liquid droplet through each of the fabric surfaces.

Many embodiments utilize only hydrophilic fabrics in a configuration to prevent liquid penetration, while allowing exit of both vapor and liquid from an inner to an outer surface. These embodiments may also isolate the skin of a user from contact with sweat, thus allowing rapid drying of the skin (e.g., keeping sweat on socks from contact with the skin and thus keeping the skin dry) even without evaporation of the liquid. As such, these embodiments can also accelerate evaporation of sweat. In handling blood or other discharge, bandages advantageously incorporate the fabric. Moreover, the fabric may be used in a non-mechanical type of one-way valve or drain.

As used, hydrophilic materials are able to prevent absorption in one direction (i.e., from the outside environment) while allowing absorption and flow in the reverse direction (i.e., from and away from the wearer's skin). This is in contrast to garments made of typical hydrophobic materials (e.g., polyester) that prevent liquid both from entering toward the skin and from exiting from the skin through the fabric. The use of hydrophilic materials to prevent absorption as provided herein is unique. The subject matter described herein includes the fabrics, products (be they consumer goods, medical devices, etc.) and the methods of use and manufacture of the fabrics and products.

Other fabrics, products, systems, devices, methods, features, and advantages of the subject matter described herein will be or will become apparent to one with skill in the art upon examination of the following figures and detailed description. It is intended that all such additional fabrics, products, systems, devices, methods, features, and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWINGS

The figures diagrammatically illustrate inventive embodiments. Variations other than those shown in the figures are contemplated as described in a broader sense herein, as generically claimed or otherwise. The figures are not necessarily drawn to scale, with some components and features being exaggerated for clarity.

FIGS. 1A and 1B are side and perspective views of an example embodiment of the diodic fabric.

FIGS. 2A-2C are views of example products incorporating the diodic fabric.

FIG. 3 illustrates an example of evaporation vs. time for a sample droplet in relation to some fabric embodiments.

### DETAILED DESCRIPTION

Before the present disclosure is described in detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either or both of those included limits are also included in the disclosure. To the extent a discrete value is stated, or an approximation of such value may be claimed, such as “about” said value or “approximately” said value, and this paragraph serves as support for such a claim unless the description explicitly states that such an approximation is not appropriate.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

Turning now to the particulars of the present subject matter, by utilizing a finite and significant (e.g., an order-of-magnitude) difference in the capillary pressure drop between two or more fabric layers (achieved by selecting layers with different chemical properties or different pore sizes) a diodic effect can be obtained where the resistance to liquid flow in one direction is different from the resistance to liquid flow in the opposite direction. This effect can be utilized to prevent external liquids from penetrating the fabric and contacting the user's skin, while allowing for extraction of droplets in contact with the inner layer (e.g., sweat) out of contact with the skin and accelerating their evaporation.

The layer with greater capillary pressure drop is hereinafter denoted as the “outer layer” and the layer with lesser capillary pressure drop as the “inner layer.” Incorporated in a fabric product, the inner layer is closer to the user or wearer's skin and the outer layer is farther from the skin.

Further, “containers” or “container regions” that include additional layers blocking the transfer of liquids may be included on one or both sides of the fabric. In one example, containers may be included if the capillary pressure within the outer layer is spatially varying. Typically, the containers will be positioned in the regions with maximal value of the capillary pressure drop.

By changing the capillary pressure within the outer-layer (the layer farther from the skin) the motion of the liquid can be controlled and hazardous droplets can be directed into safe “containers” isolated from the skin. The containers may be a region of the fabric with added impenetrable sheets (e.g., solid plastic) on both sides of the fabric. These regions will be designed to have the largest capillary pressure drop so that hazardous droplets will tend to flow into the “container” region. This will better isolate the droplets from the skin, due to the added solid sheets barrier.

Whereas the properties of the outer layer may vary and be treated per above, the properties of the inner layer are typically spatially constant. This is because the liquid droplets only move in the outer-layer. The inner-layer prevents contact with the skin; the droplets do not penetrate it and thus the inner-layer does not facilitate liquid motion.

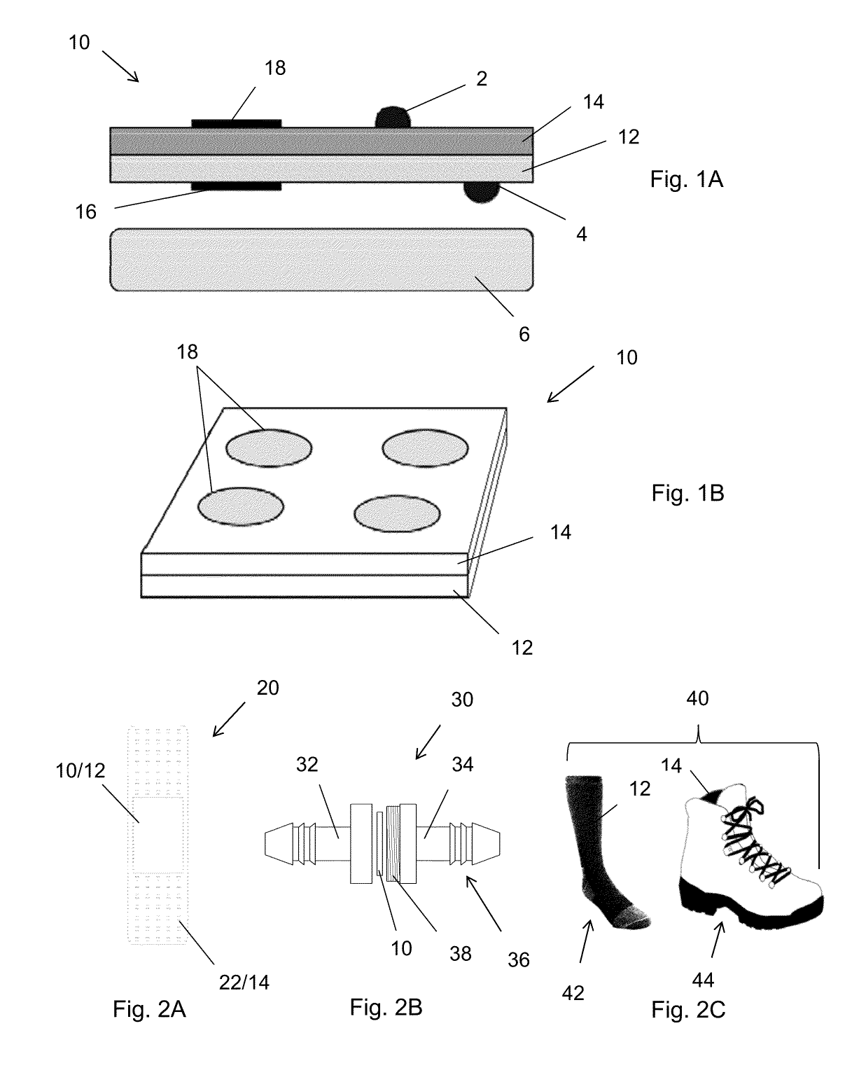

FIG. 1A illustrates a section of fabric 10 with an inner layer 12, an outer layer 14, and inner and outer layer containers 16, 18. Droplet 2 is shown penetrating into the outer layer (e.g., rain, chemical agent). Droplet 4 is shown penetrating the inner layer (e.g., sweat) in contact with the skin 6 of a user.

FIG. 1B presents another view of the double-layer diodic fabric 10 and containers 18 with the containers positioned over fabric regions with maximal capillary pressure drop.

Notably, mildly hydrophilic nylon fabrics were employed in the proof of concept demonstrated herein. Also, it is contemplated that porous metals (e.g., lithography hole-patterned) and/or metal fabrics may be employed in defining the fabric layers.

Furthermore, while two-layer fabrics are detailed, three or more layers with significantly different capillary pressures may be combined in defining the subject fabrics. Likewise, it is also contemplated that instead of employing a discrete transition of capillary pressure between the layers, a continuous change of the capillary pressure from one side of the fabric to the other may be employed by a continuous change of the average pore size from one side of the fabric to the other.

In yet another embodiment, the inner layer is porous fabric or patterned metal, and the outer layer(s) is created by spraying on a porous hydrophilic coating thereon.

In one medical application, multi-layer fabric may be employed in a bandage or BAND-AID to allow breathing of the wound without preventing liquid exiting the wound and allowing the wound to be in contact with the air. FIG. 2A illustrates such a product. In the bandage 20, the pad may comprise a dual-layer fabric 10 and the backing 22 be conventional perforated adhesive-lined polymer, stretch-type fabric material or other material typical to bandage construction. As another option, the backing may in fact be made of outer-layer 14 material with adhesive applied thereto, and the pad made of inner-layer 12 material.

In other medical applications, the fabric may be applied as a one-way valve for applications including treatment of glaucoma and brain drainage. For medical or other applications, FIG. 2B illustrates a valve device 30, in which a disk (or other convenient shape) of fabric 10 is held between complimentary housing pieces 32, 34. While shown with hose-barb fitting 36 and a treaded connection between the parts, other configurations are possible as well. Indeed, given that no mechanical parts are required, the valve is particularly suitable for miniaturization and even implantation.

Moreover, the subject approach may be applied in a combined product 40 such as a combination of clothes depicted in FIG. 2C. For example, the combination of socks 42 and footwear 44, where the inner layer 12′ will be the sock or part of the sock and the outer layer 14′ will be the footwear (e.g., a shoe or boot) or part of the footwear, can together constitute a diodic fabric assembly, which has significant and finite difference in capillary pressure that creates an effective multi-layered fabric with diodic effects.

### EXAMPLES

Different capillary pressure drops can be achieved by different pore radius and/or different wetting properties of the porous material. Experiments were conducted with hydrophilic nylon membranes (Tisch Scientific) with different average pore radius (5 μm and 0.1 μm) in order to examine the effects of inner and outer layers with order of magnitude difference in the capillary pressure drops.

### Example 1

In a first example, mass distribution between the inner and outer layers was examined for the case of a 40 μL deionized water droplet (e.g., simulating transport of a chemical agent, sweat or other material) set upon the fabric.

In one setup, inner layer average pore size was 5 μm and outer layer average pore size was 0.1 μm in diameter. When a droplet was positioned on the outer layer, 99% of the liquid mass remained in the outer layer, with a standard deviation of 5%. Thus, the liquid did not penetrate into the inner layer. For the opposite case, where a liquid droplet was positioned on the inner layer, 57% of the liquid was transferred to the outer layer, with a standard deviation of 7%.

Control experiments were also conducted for inner and outer layers with identical pore sizes of 5 μm, as well as inner and outer layers with identical pore sizes of 0.1 μm. In the first case, 54% of the liquid remained on the outer layer, with a standard deviation of 22%. In the latter case, 55% of the liquid remained on the outer layer, with a standard deviation of 20%.

As demonstrated, the use of double layer fabrics with an order of magnitude difference in capillary pressure drop essentially prevents penetration of liquid positioned on the outer layer and increases the penetration of liquid positioned at the inner layer.

### Example 2

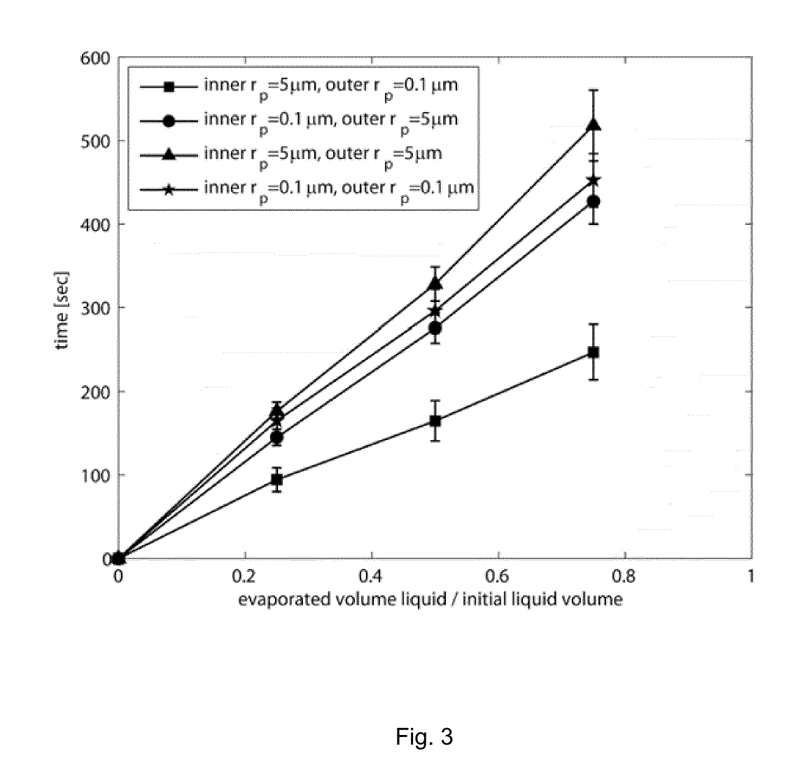

In a second example, evaporation time for a 200 μL ethanol droplet positioned on the inner-layer of fabric samples were compared as presented in FIG. 3. Here, four combinations of inner and outer layer pore sizes are plotted as indicated in the figure's legend.

Notably, the case in which the outer layer pore size is an order of magnitude smaller than the inner layer (i.e., 5 μm inner with 0.1 μm outer) presented much lower time for evaporation. This result provides a strong indication that such a combination can be used to increase the rate of liquid evaporation.

Variations

Reference to a singular item includes the possibility that there are a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the different inventive embodiments or aspects described herein is not to be limited to the examples provided and/or the subject specification, but rather only by the scope of the issued claim language. Various changes may be made to the embodiments described and equivalents (whether recited herein or not included for the sake of some brevity) may be substituted without departing from the true spirit and scope of the invention. It should be noted that all features, elements, components, functions, and steps described with respect to any embodiment of the present subject matter are intended to be freely combinable and substitutable with those from any other embodiment.

If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

1. A diodic fabric product, comprising:
a plurality of fabric layers, at least two layers of the plurality of fabric layers having different capillary pressures,
wherein the at least two layers produce asymmetric resistance to liquid flow from one side of the plurality of fabric layers to the other, whereby the at least two layers define a diodic fabric.

2. The diodic fabric product of claim 1, wherein only two layers of fabric define the diodic fabric.

3. The diodic fabric product of claim 1, wherein the layers of fabric comprise hydrophilic material.

4. The diodic fabric product of claim 1, wherein an inner layer includes pores of about 0.1 μm radius.

5. The diodic fabric product of claim 4, wherein an outer layer includes pores of about 5 μm radius.

6. The diodic fabric product of claim 1, wherein an outer layer includes pores of about 5 μm radius.

7. The diodic fabric product of claim 1, wherein an inner layer includes pores having a first radius, and an outer layer include pores having a second radius, the first radius being at least an order of magnitude different that the second radius.

8. The diodic fabric product of claim 7, wherein the first radius is at least about 50 times different in magnitude from the second radius.

9. The diodic fabric product of claim 7, wherein the first radius is about 50 times different in magnitude from the second radius.

10. The diodic fabric product of claim 1, wherein the fabric has spatially varying capillary pressure reaching a maximum within a protected container.

11. The diodic fabric product of claim 1, including an adhesive-lined backing for a bandage interface.

12. The diodic fabric product of claim 11, wherein the backing is one of the plurality of fabric layers.

13. The diodic fabric product of claim 11, wherein the backing is not one of the plurality of fabric layers.

14. The diodic fabric product of claim 1, further comprising a housing, wherein the fabric layers are set within the housing to define a one-way valve.

15. The diodic fabric product of claim 1, wherein a first one of the at least two layers is present in a first article of clothing, and a second one of the at least two layers is present in a second article of clothing different from the first article of clothing.

16. The diodic fabric of claim 15, wherein the first article of clothing is a sock and the second article of clothing is a shoe or boot.

17. A diodic product, comprising:
a plurality of layers, at least two layers of the plurality of layers having different capillary pressures,
wherein the at least two layers produce asymmetric resistance to liquid flow from one side of the plurality of fabric layers to the other thereby providing a diodic fabric.

18. The diodic product of claim 17, wherein an inner layer comprises a fabric.

19. The diodic product of claim 17, wherein an outer layer comprises a porous hydrophilic spray coating.

20. The diodic product of claim 17, wherein at least one of the layers is metallic.
